(19) United States
(12) Patent Application Publication
(10) Pub. No.: US 2019/0293746 A1
(43) Pub. Date: Sep. 26, 2019

(54) ELECTRONIC DEVICE FOR ESTIMATING POSITION OF SOUND SOURCE

(71) Applicant: ELECTRONICS AND TELECOMUNICATIONS RESEARCH INSTITUTE, Daejeon (KR)

(72) Inventors: Sung Q LEE, Daejeon (KR); Kang-Ho PARK, Daejeon (KR); Yi-Gyeong KIM, Daejeon (KR)

(73) Assignee: ELECTRONICS AND TELECOMUNICATIONS RESEARCH INSTITUTE, Deajeon (KR)

(21) Appl. No.: 16/264,550

(22) Filed: Jan. 31, 2019

(30) Foreign Application Priority Data
Mar. 26, 2018 (KR) 10-2018-0034643

(51) Int. Cl. G01S 5/30; H04R 1/40

(52) U.S. Cl. CPC G01S 5/30; H04R 1/406

(57) ABSTRACT

Provided is an electronic device including a first microphone array including a plurality of microphones configured to generate first signals related to a first sound in response to the first sound from a sound source, and a processor configured to generate a first result related to a first direction to the sound source from a first reference position among first positions at which the first sound is received by the plurality of microphones based on second signals corresponding to a second sound received from the sound source at second positions separated from the first positions and the first signals, and generate a second result related to a distance to the sound source based on information on a second direction from a second reference position among the second positions to the sound source and the first result.

### CROSS-REFERENCE TO RELATED APPLICATIONS

This U.S. non-provisional patent application claims priority under 35 U.S.C. § 119 of Korean Patent Application No. 10-2018-0034643, filed on Mar. 26, 2018, the entire contents of which are hereby incorporated by reference.

### BACKGROUND

The present disclosure herein relates to an electronic device and, more particularly, to configurations and operations of an electronic device for estimating the position of a sound source.

The position of a sound source may be estimated using the level, time difference, phase, etc. of the sound input to the microphone. There are various fields to which the technique of estimating the position of a sound source using a microphone may be applied.

As an example, if the distance of the speaker from the recorder may be grasped, the input gain of the recorder may be adjusted depending on the distance. If the speaker is far away, the input gain of the recorder is increased and if the speaker is near, the input gain of the recorder is low. Therefore, a more effective recording operation may be possible.

As another example, if the position of the sound source may be determined, dangerous accidents may be prevented. An aged person with a reduced ability to recognize the position of a sound source due to aging may pass through near the construction site and be in danger. Also, even in the case of an ordinary person, if an ordinary person does not recognize a vehicle approaching from behind while walking on the road and wearing earphones, an accident may occur. In this case, if the position of the sound source is notified, such as by stimulating or giving a warning, an accident may be prevented.

### SUMMARY

The inventive concept relates to configurations and operations of an electronic device for estimating the position of a sound source using a microphone. In the embodiments of the inventive concept, an electronic device may estimate the position of the sound source more precisely by using the extended microphone array set than when estimating the position of the sound source by using the single microphone array.

An embodiment of the inventive concept provides an electronic device including: a first microphone array including a plurality of microphones configured to generate first signals related to a first sound in response to the first sound from a sound source; and a processor configured to generate a first result related to a first direction to the sound source from a first reference position among first positions at which the first sound is received by the plurality of microphones based on second signals corresponding to a second sound received from the sound source at second positions separated from the first positions and the first signals, and generate a second result related to a distance to the sound source based on information on a second direction from a second reference position among the second positions to the sound source and the first result.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a block diagram illustrating a configuration for estimating a position of a sound source using an electronic device according to an embodiment of the inventive concept;

FIG. 2 is a conceptual diagram for explaining a method of estimating a position of a sound source using a plurality of microphones;

FIG. 3 is a block diagram illustrating an exemplary configuration of the electronic device of FIG. 1;

FIG. 4 is a block diagram illustrating an exemplary configuration of the electronic device of FIG. 1;

FIG. 5 is a conceptual diagram for explaining an exemplary method of measuring the position of a sound source using a plurality of electronic devices;

FIG. 6 is a flowchart illustrating one embodiment of communication between the electronic devices of FIG. 5;

FIG. 7 is a block diagram illustrating a configuration for measuring the position of a sound source using an electronic device according to an embodiment of the inventive concept when the electronic device is moved;

FIG. 8 is a block diagram illustrating an exemplary configuration of the electronic device of FIG. 7;

FIG. 9 is a conceptual diagram for explaining an exemplary method of measuring the position of a sound source using the electronic device of FIG. 8 when the electronic device is moved;

FIG. 10 is a flowchart for explaining an exemplary method of measuring the position of a sound source using the electronic device of FIG. 8;

FIG. 11 is a block diagram illustrating a configuration for estimating the position of a sound source using a plurality of electronic devices when the electronic device is moved;

FIG. 12 is a block diagram illustrating an exemplary configuration of the electronic device of FIG. 11;

FIG. 13 is a block diagram illustrating an exemplary configuration of the electronic device of FIG. 11; and

FIG. 14 is a flowchart illustrating one embodiment of communication between the electronic devices of FIG. 11.

### DETAILED DESCRIPTION

The above-mentioned characteristics and following detailed descriptions are all exemplary details to help describing and understanding the inventive concept. That is, the inventive concept may be embodied in different forms without limited to such embodiments. The following embodiments are merely illustrative for fully disclosing the inventive concept, and described for delivering the inventive concept to those skilled in the art. Accordingly, if there are several methods for implementing components of the inventive concept, it should be clarified that it is possible to implement the inventive concept through a specific one among those methods or any one of methods having the identity thereto.

If there is a mention that a certain configuration includes specific elements or a certain process includes specific steps, it means that other elements or other steps may be further included. That is, the terms used herein are merely intended to describe particular embodiments, and are not intended to limit the inventive concept. Furthermore, examples described to help understanding the inventive concept include their complementary embodiments.

The terms used herein have meanings that those skilled in the art commonly understand. The commonly-used terms should be construed as a consistent meaning in the context of the specification. Additionally, unless clearly defined, the terms used herein should not be construed as excessively ideal or formal meanings. Hereinafter, embodiments of the inventive concept are described with reference to the accompanying drawings.

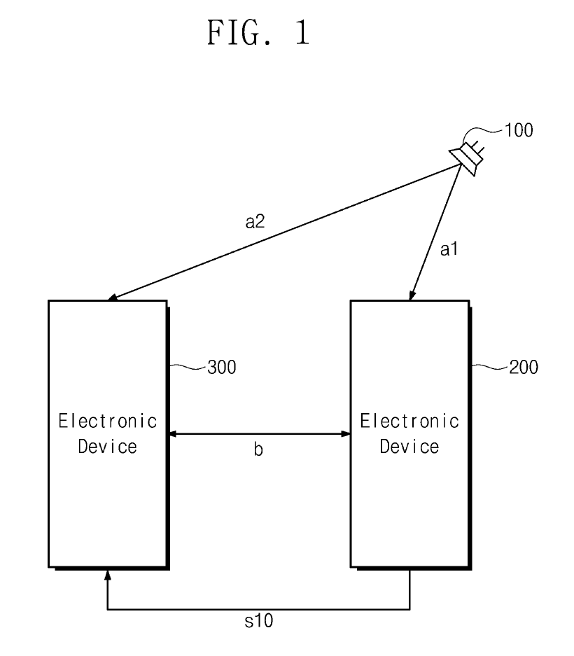

FIG. 1 is a block diagram illustrating a configuration for estimating a position of a sound source using an electronic device according to an embodiment of the inventive concept.

Each of electronic devices 200 and 300 may be configured to estimate or measure the position of the sound source 100. Each of electronic devices 200 and 300 may be configured to estimate or measure the position of the sound source 100. The sound source 100 may be any object capable of outputting sound. As an example, the sound source 100 may be a fixed sound source, such as a speaker, or may be a sound source that moves like a car.

The electronic device 300 may be located a distance b from the electronic device 200. As an example, the electronic devices 200, 300 may be implemented with a tool that may be worn by a person, such as a pair of glasses, or may be implemented as a wearable electronic device, such as an earphone, Earbud, Neckband headphone, and the like. By way of example, the electronic devices 200 and 300 may be wearable tools or devices that are spaced apart from each other on both sides of the electronic device (e.g., earphone set for the left ear and earphone set for the right ear). In this case, the distance b between the electronic devices 200 and 300 may have a value that is substantially fixed, and information on the distance b may be provided to the electronic devices 200 and 300 in advance (before the electronic devices 200 and 300 operate).

The electronic device 200 may include a plurality of microphones constituting one microphone array. The electronic device may receive sound a1 from the sound source 100 through a plurality of microphones. The electronic device 200 may estimate the position of the sound source 100 based on the sound a1.

The electronic device 200 may generate a signal s10. The signal s10 may include information on the position of the sound source 100 estimated based on the position of the electronic device 200. The electronic device 200 may transmit the signal s10 to the electronic device 300.

The electronic device 300 may include a plurality of microphones constituting one microphone array. The microphone array composed of the microphones of the electronic device 300 may be physically independent of the microphone array composed of the microphones of the electronic device 200. Thus, the positions of the microphones of the electronic device 300 may be separated from the positions of the microphones of the electronic device 200.

The electronic device 300 may receive a sound a2 from the sound source 100 through a plurality of microphones. The electronic device 300 may estimate the position of the sound source 100 based on the sound a2.

The electronic device 300 may receive a signal s10 from the electronic device 200. The electronic device 300 may estimate the position of the sound source 100 based on the sound a2 and the signal s10.

Below, although it is described with reference to FIGS. 1 to 7 that the electronic device 300 estimates the position of the sound source 100 using one electronic device 200, the inventive concept is not limited thereto. The electronic device 300 may measure the position of the sound source 100 using a plurality of electronic devices.

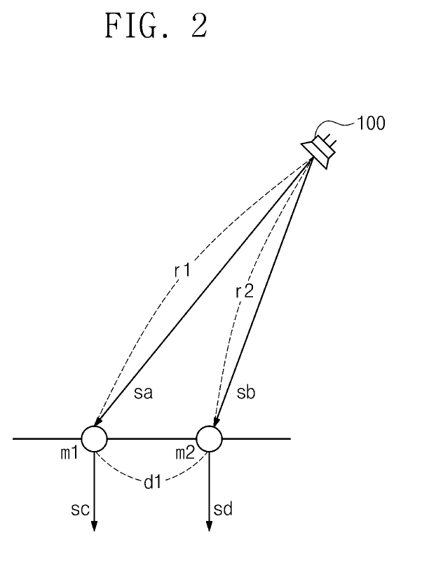

FIG. 2 is a conceptual diagram for explaining a method of estimating a position of a sound source using a plurality of microphones.

A plurality of microphones may be used to estimate the position of the sound source 100. For example, FIG. 2 shows an example using two microphones m1 and m2, but the inventive concept is not limited thereto.

Sounds sa and sb may be generated at the sound source 100. As an example, the sounds sa and sb may be outputted at substantially the same time from the sound source 100. The microphones m1 and m2 may receive sounds sa and sb from the sound source 100, respectively. On the other hand, as the positions of the microphones m1 and m2 are somewhat different, the characteristics (e.g., strength, arrival time, etc.) of the sounds sa and sb received by the microphones m1 and m2 are somewhat different.

Due to the difference between the distance r1 from the sound source 100 to the microphone m1 and the distance r2 from the sound source 100 to the microphone m2, the time at which the sound sa reaches the microphone m1 and the time at which the sound sb reaches the microphone m2 may be different. The difference between the time when the sound sa reaches the microphone m1 and the time when the sound sb reaches the microphone m2 may be called the arrival time difference τ12. Referring to Equation 1, the arrival time difference τ12 is as follows.

$${τ}_{12} = \frac{r 1 - r 2}{c} \qquad [ Equation 1 ]$$

“r1” may indicate the distance from the microphone m1 to the sound source 100. “r2” may indicate the distance from the microphone m2 to the sound source 100. “c” may indicate the speed of the sounds sa and sb generated from the sound source 100. The speeds of the respective sounds sa and sb generated in the same sound source 100 may be substantially the same.

A method such as Time Difference of Arrival (TDOA) may be used to estimate the position of a sound source using a plurality of microphones. A method such as TDOA may be used to estimate the position of the sound source using the arrival time difference.

The microphone m1 may be located a distance dl away from the microphone m2. The difference between the distance r1 and the distance r2 may vary depending on the distance dl between the microphones m1 and m2. Thus, the arrival time difference τ12 may be affected by the distance dl between the microphones m1 and m2. As an example, if the distance dl between the microphones m1, m2 is getting farther, the arrival time difference τ12 may increase.

The microphones m1 and m2 may generate signals sc and sd in response to sounds sa and sb, respectively. The signal sc may be an electrical signal representing the sound perceived by the microphone m1 and the signal sd may be an electrical signal representing the sound perceived by the microphone m2. By way of example, the signal sc may have a signal level corresponding to the intensity of the sound received by the microphone m1.

As the characteristics (e.g., intensity, time of arrival, etc.) of the sounds received by the microphones m1, m2 are somewhat different, the microphones m1, m2 may generate different signals sc and sd. For example, the signal level of the signal sc generated in the microphone m1 may be different from the signal level of the signal sd generated in the microphone m2. For example, the phase of the signal sc generated in the microphone m1 may be different from the phase of the signal sd generated in the microphone m2 in correspondence to the arrival time difference τ12.

As an example, the electronic device 300 may calculate arrival time differences from signals generated from microphones in the electronic device 300. The electronic device 300 may estimate or measure the position of the sound source 100 based on arrival time differences. As the position estimation performance of the electronic device 300 becomes better, the error between the position of the sound source 100 estimated by the electronic device 300 and the actual position of the sound source 100 may be reduced.

Using the TDOA method, the estimated performance of the electronic device 300 may be affected by the distance between the microphones. As an example, as the distance between the microphones is increased, the estimation performance of the distance becomes better. However, when the distance between the microphones inside the electronic device 300 increases, the size of the electronic device 300 may increase, and the cost of creating the electronic device 300 may increase. In addition, an increase in the distance between the microphones may make it difficult to estimate the direction to the sound source 100.

Thus, the inventive concept may use the electronic device 200 instead of increasing the distance between the microphones inside the electronic device 300. The electronic device 300 may operate similar to the use of microphones located a distance b from the electronic device 300 by using microphones within the electronic device 200.

The electronic device 300 may estimate or measure the direction to the sound source 100 using internal microphones. Furthermore, the electronic device 300 may estimate or measure the position of the sound source 100, in consideration of the direction of the sound source 100 that is estimated or measured in the electronic device 200. Therefore, as described with reference to FIG. 1, when the electronic device 300 estimates the position of the sound source 100 using the electronic device 200, the position estimation performance of the electronic device 300 may be more improved than when the electronic device 300 estimates the position of the sound source 100 without the electronic device 200.

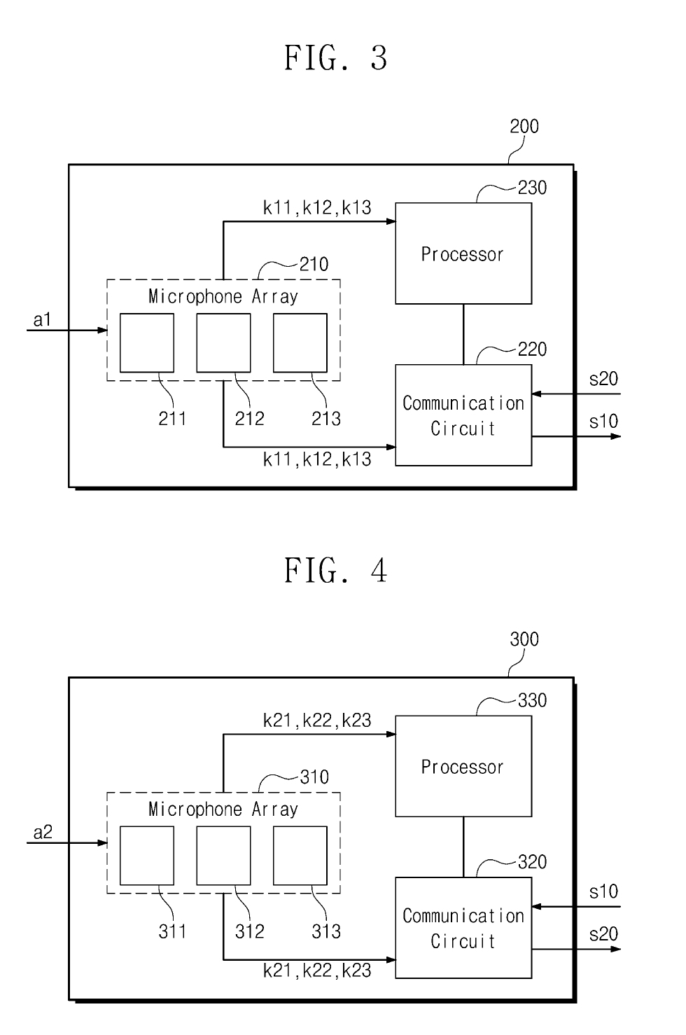

FIG. 3 is a block diagram illustrating an exemplary configuration of the electronic device of FIG. 1.

The electronic device 200 may include a microphone array 210, a communication circuit 220, and a processor 230. However, FIG. 3 only illustrates an exemplary configuration of the electronic device 200, and the electronic device 200 may further include other configurations not shown in FIG. 3. Alternatively, the electronic device 200 may not include one or more of the configurations 210, 220, 230 shown in FIG. 3.

The microphone array 210 may include a plurality of microphones. By way of example, the microphone array 210 may include three microphones 211, 212, and 213, but the inventive concept is not limited thereto.

The microphone array 210 may receive a sound a1 through the microphones 211, 212, and 213. The microphones 211, 212, and 213 may generate the signals k11, k12 and k13, respectively, based on the sound a1. As described with reference to FIG. 2, the times at which the sound a1 reaches the microphones 211, 212, and 213 may be different. Accordingly, the signals k11, k12, and k13 generated by the microphones 211, 212, and 213 may be different from each other.

The communication circuit 220 may receive signals k11, k12, and k13 from the microphone array 210. The communication circuit 220 may generate the signal s10 based on the signals k11, k12, and k13. The communication circuit 220 may transmit the signal s10 to the electronic device 300. As an example, the signal s10 includes information (e.g., a waveform corresponding to the sound a1, a change in intensity of the sound a1, etc.) on the sound a1 recognized by each of the microphones 211, 212 and 213. By way of example, the signal s10 may include information on the position of each of the microphones 211, 212, and 213.

Although not shown in FIG. 1, the communication circuit 220 may receive the signal s20 from the electronic device 300. The signal s20 may include information on the sound a2 recognized in the electronic device 300 and information on the direction from the position of the electronic device 300 to the sound source 100.

The processor 230 may generate a result related to the position of the sound source 100. The results generated by the processor 230 may be a base for estimating the position of the sound source 100. As an example, the results generated in the processor 230 may generate a result related to the direction from the reference position of the electronic device 200 to the sound source 100 and the distance from the reference position of the electronic device 200 to the sound source 100. By way of example, the reference position of the electronic device 200 may be selected as the position of one of the microphones 211, 212, and 213, but the inventive concept is not limited thereto.

The processor 230 may receive signals k11, k12, and k13 from the microphone array 210. The processor 230 may calculate an arrival time difference between times when the sound a1 is received in the microphones 211, 212, and 213 based on signals k11, k12, and k13. By way of example, the processor 230 may calculate an arrival time difference based on the phase difference between the signals k11, k12, and k13. By way of example, the processor 230 may calculate the difference between times when sound a1 is received at the positions of the microphones 211, 212, and 213 based on the waveforms of the signals k11, k12, and k13 having the phase difference.

The processor 230 may generate a first result related to the position of the sound source 100 from the reference position of the electronic device 200 based on the arrival time difference. The first result may include information on the direction from the reference position of the electronic device 200 to the sound source 100. The signal s10 may include information on the direction from the reference position of the electronic device 200 to the sound source 100 based on the first result.

The processor 230 may receive a signal s20 from the communication circuit 220. The processor 230 may generate a second result related to the position of the sound source 100 based on the signal s20 and the signals k11, k12, and k13. The second result may be based on information on the position of the sound source 100 from the reference position of the electronic device 200 and information on the position of the sound source 100 from the position of the electronic device 300. The second result may include information on the direction from the reference position of the electronic device 200 to the sound source 100. The signal s10 may include information on the direction from the reference position of the electronic device 200 to the sound source 100 based on the second result.

As described with reference to FIG. 2, an error between the position of the sound source 100 estimated from the first result only using the signals k11, k12, and k13 and the actual position of the sound source 100 may be less than an error between the position of the sound source 100 estimated from the second result using the signals k11, k12, k13 and the signal s20 and the actual position of the sound source 100. That is, the position of the sound source 100 estimated using a plurality of physically independent microphone arrays may be more precise than the position of the sound source 100 estimated using a single microphone array.

However, the inventive concept is not limited to this, and the processor 230 may generate various results related to the position of the sound source 100 based on the signals k11, k12, and k13, the signal s20, and the results generated in the processor 230. In addition, the signal s10 may include various information contained in the result generated by the processor 230.

FIG. 4 is a block diagram illustrating an exemplary configuration of the electronic device of FIG. 1.

The electronic device 300 may include a microphone array 310, a wireless communication circuit 320, and a processor 330. However, FIG. 4 only illustrates an exemplary configuration of the electronic device 300, and the electronic device 300 may further include and other circuits and other configurations not shown in FIG. 4.

The configurations 310, 320, and 330 of the electronic device 300 may operate substantially the same as or similar to the configurations 210, 220, and 230 of the electronic device 200.

The microphone array 310 may include a plurality of microphones. By way of example, the microphone array 310 may include three microphones 311, 312, and 313, but the inventive concept is not limited thereto.

The microphone array 310 may receive a sound a2 through the microphones 311, 312, and 313. The microphones 311, 312, and 313 may generate the signals k21, k22, and k23, respectively, based on the sound a2. The signals k21, k22, and k23 generated by the microphones 311, 312, and 313 may be different from each other.

The communication circuit 320 may receive the signal s10 from the communication circuit 220. As an example, the signal s10 includes information (e.g., a waveform corresponding to the sound a1, a change in intensity of the sound a1, etc.) on the sound a1 recognized by each of the microphones 211, 212 and 213. The signal s10 may include information on the sound a1 based on the signals k11, k12, and k13. In addition, the signal s10 may include information on the position of the sound source 100 from the reference position of the electronic device 200. As an example, the signal s10 may include information on the times when the sound a1 reaches the microphones 211, 212, and 213, information on the direction from the reference position of the electronic device 200 based on the first result to the sound source 100, and information on the direction from the reference position of the electronic device 200 based on the second result to the sound source 100.

The processor 330 may receive signals k21, k22, k23 and a signal s10. The processor 330 may generate a result related to the position of the sound source 100 based on the signals k21, k22, k23 and/or the signal s10. The results generated by the processor 330 may be a base for estimating the position of the sound source 100. As an example, the results generated in the processor 330 may generate a result related to the direction from the reference position of the electronic device 300 to the sound source 100 and the distance from the reference position of the electronic device 300 to the sound source 100. By way of example, the reference position of the electronic device 300 may be selected as the position of one of the microphones 311, 312, and 313, but the inventive concept is not limited thereto.

Similar to the processor 230 described with reference to FIG. 3, the processor 330 may generate a third result related to the position of the sound source 100 from the position of the electronic device 300 based on the signals k21, k22, and k23. The third result may be generated through a method similar to the generation of the first result described with reference to FIG. 3. The third result may include information on the direction from the reference position of the electronic device 300 to the sound source 100. The signal s20 may include information on the direction from the reference position of the electronic device 300 to the sound source 100 based on the third result.

As an example, when the signal s10 includes information on the sound a1 recognized by the microphones 211, 212, and 213, the processor 330 may generate a fourth result related to the position of the sound source 100 from the reference position of the electronic device 300 based on the signal s10. The fourth result may be generated through a method similar to the generation of the second result described with reference to FIG. 3. The fourth result may include information on the direction from the reference position of the electronic device 300 to the sound source 100. The signal s20 may include information on the direction from the reference position of the electronic device 300 to the sound source 100 based on the fourth result.

As described with reference to FIG. 2, an error between the position of the sound source 100 estimated from the third result only using the signals k21, k22, and k23 and the actual position of the sound source 100 may be less than an error between the position of the sound source 100 estimated from the fourth result using the signals k21, k22, and k23 and the signal s10 and the actual position of the sound source 100.

The processor 330 may generate a fifth result based on the information on the direction from the reference position of the electronic device 200 to the sound source 100 and the information on the direction from the reference position of the electronic device 300 to the sound source 100. The fifth result may include information on the distance from the reference position of the electronic device 300 to the sound source 100.

For example, the processor 330 may generate a fifth result based on the information on the direction from the reference position of the electronic device 200 based on the first result to the sound source 100 and the information on the direction from the reference position of the electronic device 300 based on the fourth result to the sound source 100. The processor 330 may calculate a target position that corresponds to one of the positions on the path along the direction from the reference position of the electronic device 200 to the sound source 100 among the positions on the path along the direction from the reference position of the electronic device 300 to the sound source 100. The processor 330 may generate a fifth result based on the distance between the reference position and the target position of the electronic device 300.

The fifth result may include information on the direction from the reference position of the electronic device 300 to the sound source 100 and information on the distance from the reference position of the electronic device 300 to the sound source 100. The position of the sound source 100 may be measured from the fifth result.

However, the inventive concept is not limited to that the processor 330 may generate a fifth result based on the information on the direction from the reference position of the electronic device 200 based on the first result to the sound source 100 and the information on the direction from the reference position of the electronic device 300 based on the fourth result to the sound source 100. The processor 330 may generate the fifth result based on the information in the second result instead of the information in the first result or based on the information in the third result instead of the information in the fourth result.

The communication circuit 320 may receive signals k21, k22, and k23 from the microphone array 310. The communication circuit 320 may generate the signal s20 based on the signals k21, k22, and k23. The communication circuit 320 may transmit the signal s20 to the communication circuit 220 of the electronic device 200.

The signal s20 may include information on the position of the sound source 100 from the reference position of the electronic device 300. For example, the signal S20 may include information on the direction from the reference position of the electronic device 300 to the sound source 100 and the distance from the reference position of the electronic device 300 to the sound source 100.

However, the inventive concept is not limited to this, and the processor 330 may generate various results related to the position of the sound source 100 based on the signals k21, k22, and k23, and the signal s10, that is, the results generated by the processor 330. In addition, the signal s20 may include various information contained in the result generated by the processor 330.

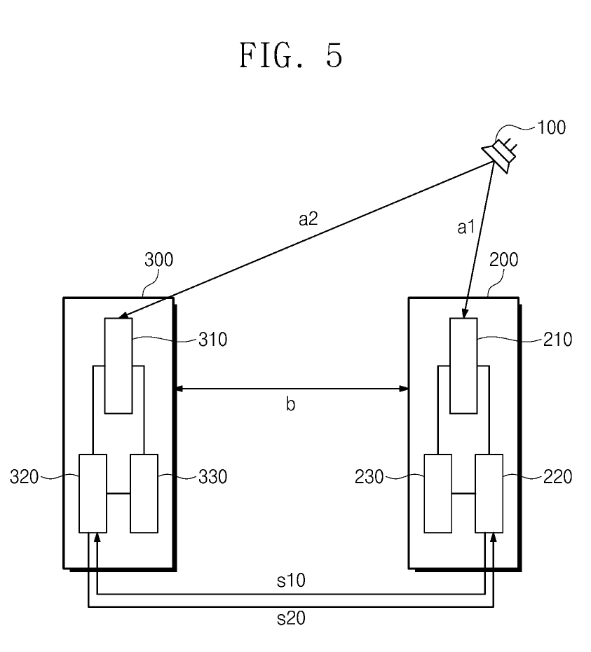

FIG. 5 is a conceptual diagram for explaining an exemplary method of measuring the position of a sound source using a plurality of electronic devices. FIG. 5 may illustrate a method of generating a fifth result based on the information included in the first result of FIG. 3 and the information included in the fourth result of FIG. 4. In order to help understanding of the inventive concept, FIGS. 3 and 4 are referenced together.

The microphone array 210 may generate signals k11, k12, and k13, respectively, based on the sound a1 received by the microphones 211, 212, and 213. As described with reference to FIG. 3, the processor 230 may generate a first result related to the position of the sound source 100 estimated from the reference position of the electronic device 200 based on the signals k11, k12, and k13. The first result may include information on the direction from the reference position of the electronic device 200 to the sound source 100.

The communication circuit 220 may transmit the signal s10 to the communication circuit 320. Based on the signals k11, k12, and k13, the signal s10 may include information on the sound a1 recognized by the microphones 211, 212, and 213. Also, the signal may include information on the direction from the reference position of the electronic device 200 based on the first result to the sound source 100.

The microphone array 310 may generate signals k21, k22, and k23, respectively, based on a sound a2 received by the microphones 311, 312, and 313. The communication circuit 320 may receive the signal s20 from the communication circuit 220. The signal s20 includes information on the sound a1 recognized by the microphones 211, 212 and 213 and information on the direction from the reference position of the electronic device 200 based on the first result to the sound source 100. The fourth result may include information on the direction from the reference position of the electronic device 300 to the sound source 100.

As described with reference to FIG. 4, the processor 330 may generate a fifth result based on the information on the direction from the reference position of the electronic device 200 based on the first result to the sound source 100 and the information on the direction from the reference position of the electronic device 300 based on the fourth result to the sound source 100. The fifth result may include information on the distance from the reference position of the electronic device 200 to the sound source 100.

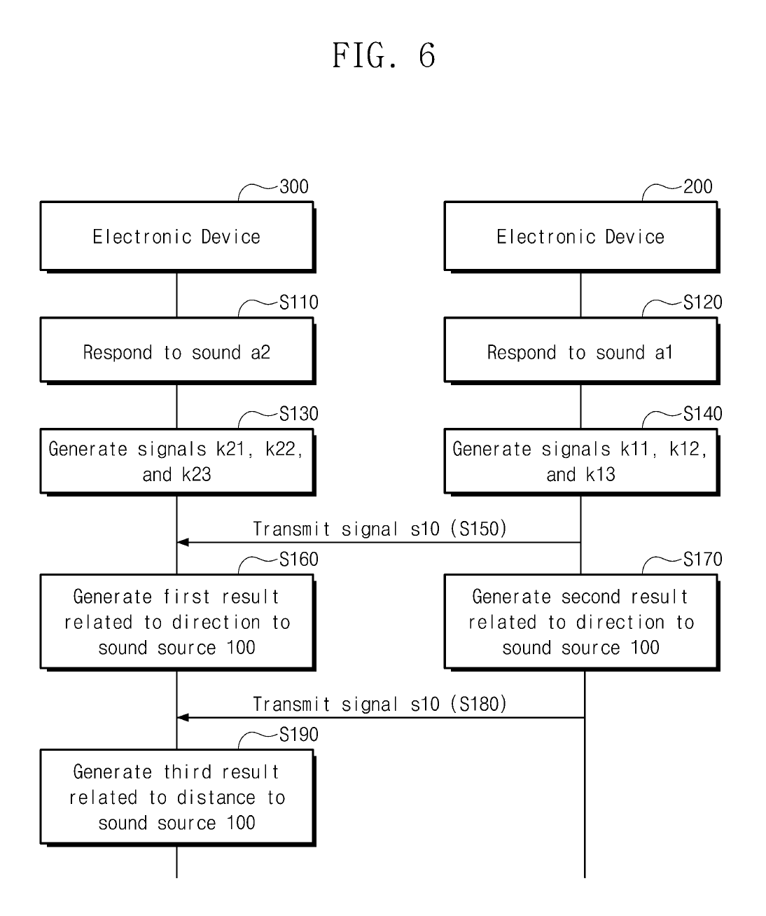

FIG. 6 is a flowchart illustrating one embodiment of communication between the electronic devices of FIG. 5.

In operation S110, the microphone array 310 may receive a sound a2. Also, in operation S130, the microphone array 310 may generate signals k21, k22, and k23 based on the sound a2.

On the other hand, in S120 operation, the microphone array 210 may receive the sound a1. In operation S140, the microphone array 210 may generate signals k11, k12, and k13 based on the sound a1. Due to differences between the distances from the sound source 100 to the respective microphone arrays 210 and 310, the waveforms of the signals k21, k22, and k23 and the signals k11, k12, and k13 may be different from each other. As an example, the signal levels of the signals k11, k12, k13, k21, k22, and k23 may be different, and there may be phase differences between the signals k11, k12, k13, k21, k22, and k23.

In operation S150, the communication circuit 220 may transmit the signal s10. The signal s10 may include information on the sound a1 recognized by the microphones 211, 212, and 213, respectively. The signal s10 may be generated based on signals k11, k12, and k13. The communication circuit 320 may receive the signal s10.

In operation S160, the processor 330 may receive the signal s10 and the signals k21, k22, and k23. The processor 330 may generate a first result based on the signal s10 and the signals k21, k22, and k23. The first result may include information on the direction from the reference position of the electronic device 300 to the sound source 100. As an example, the processor 330 may calculate the phase differences between the signals k11, k12, k13, k21, k22, and k23 based on the signal s10 and the signals k21, k22, and k23. By way of example, the processor 330 may calculate the direction from the calculated phase differences to the sound source 100 according to the TDOA and Maximum Likelihood (ML) methods.

In operation S170, the processor 230 may receive the signals k11, k12, and k13. The processor 230 may generate a second result based on the signals k11, k12, and k13. The second result may include information on the direction from the reference position of the electronic device 200 to the sound source 100. By way of example, the processor 230 may calculate the phase differences between the signals k11, k12, and k13, and thus may calculate the direction to the sound source 100.

In operation S180, the communication circuit 220 may transmit the signal s10 to the communication circuit 320. The signal s10 may include information on the direction from the reference position of the electronic device 200 to the sound source 100 based on the second result. The communication circuit 320 may receive the signal s10.

In operation S190, the processor 330 may receive the signal s10. The processor 330 may generate a third result based on the information on the direction from the reference position of the electronic device 300 based on the first result to the sound source 100 and the information on the direction from the reference position of the electronic device 200 based on the second result to the sound source 100. The third result may include information on the distance from the reference position of the electronic device 300 to the sound source 100.

Referring to FIG. 5 together, when a first direction from the electronic device 300 to the sound source 100 and a second direction from the electronic device 200 to the sound source 100 are obtained, the position of the sound source 100 may be estimated. The position where a straight line connecting the electronic device 300 and the sound source 100 (i.e., a path along the first direction from the electronic device 300) intersects a straight line connecting the electronic device 200 and the sound source 100 (i.e., a path along the second direction from the electronic device 200) may be a target position at which the sound source 100 is estimated to be placed. The distance between the electronic device 300 and the target position may be estimated as the distance between the positions of the electronic device 300 and the sound source 100.

The third result may include information on the direction from the reference position of the electronic device 300 to the sound source 100 and information on the distance from the reference position of the electronic device 300 to the sound source 100. The direction and distance to the sound source 100 may be used to identify the position of the sound source 100. Thus, the third result may be referred to in estimating or measuring the position of the sound source 100. However, the inventive concept is not limited to the embodiment described with reference to FIG. 6.

As an example, in operation S150, the communication circuit 320 may transmit the signal s20. The signal s20 may include information on the sound a2 based on the signals k21, k22, and k23. The communication circuit 220 may receive the signal s20. In this case, in operation S170, the processor 230 may receive the signal s20 and the signals k11, k12, and k13. The processor 230 may generate a second result based on the phase differences between the signals k11, k12, k13, k21, k22, and k23.

As another example, in operation S180, the communication circuit 320 may transmit the signal s20 to the communication circuit 220. The signal s20 may include information on the direction from the reference position of the electronic device 300 to the sound source 100 based on the first result. The communication circuit 220 may receive the signal s20. In this case, in operation S190, the processor 230 may receive the signal s20. The processor 230 may generate a third result based on the information on the direction from the reference position of the electronic device 300 based on the first result to the sound source 100 and the information on the direction from the reference position of the electronic device 200 based on the second result to the sound source 100. The third result may include information on the distance from the reference position of the electronic device 200 to the sound source 100.

For the operation of FIG. 6, the set of electronic devices 300 may be spatially separated from the set of electronic devices 200. The electronic device 200 may be understood as an external device in terms of the electronic device 300. The microphone array 310, the communication circuit 320, and the processor 330 may constitute a first set of devices (e.g., earphone sets for the left ear), and the microphone array 210, the communication circuit 220, and processor 230 may constitute a second set of devices (e.g., earphone sets for the right ear) that are physically independent of the first device set.

That is, one embodiment of the inventive concept may implement microphone arrays that are geometrically or spatially extended using electronic devices 200 and 300, instead of forming a single microphone array. The directions to the sound source 100 estimated or measured by each of the electronic devices 200 and 300 may be used complementarily, and the position of the sound source 100 may be precisely estimated or measured.

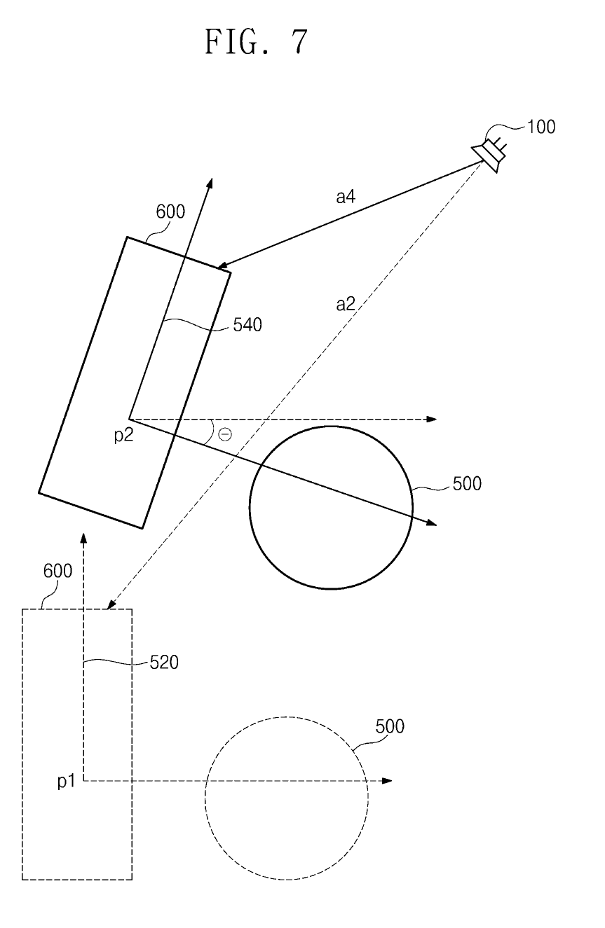

FIG. 7 is a block diagram illustrating a configuration for measuring the position of a sound source using an electronic device according to an embodiment of the inventive concept when the electronic device is moved.

The electronic device 600 may be moved from a position p1 to a position p2 over time. Thus, the position p1 may be separated from the position p2. As an example, in a case where the electronic device 600 is implemented in an electronic device that may be worn by the user 500, such as earphones and headphones, as the user 500 moves from the position p1 to the position p2, the electronic device 600 may also be moved from the position p1 to the position p2.

As the electronic device 600 is moved from the position p1 to the position p2, the direction in which one surface of the electronic device 600 faces may be rotated by the angle θ. The coordinate axis indicating the position of the electronic device 600 may be changed from the coordinate axis 520 to the coordinate axis 540.

The position p1 may be the reference position of the electronic device 600 before it is moved. The electronic device 600 may receive a sound a2 from a sound source 100 at the position p1. The position p2 may be the reference position of the electronic device 600 after it is moved. The electronic device 600 may receive a sound a4 from a sound source 100 at the position p2. The electronic device 600 may estimate or measure the position of the sound source 100 based on the sound a2 and the sound a4.

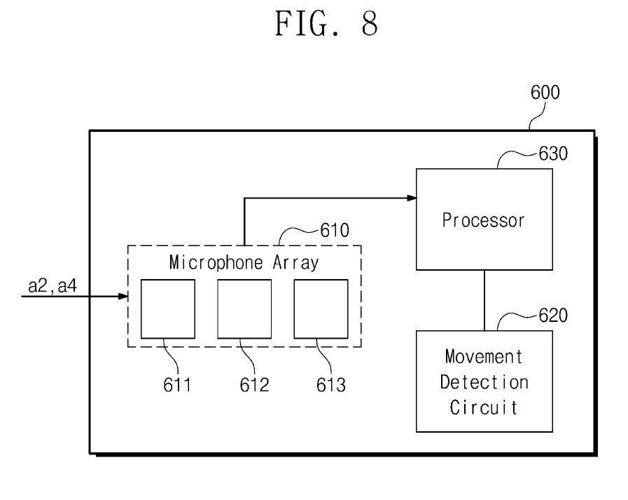

FIG. 8 is a block diagram illustrating an exemplary configuration of the electronic device of FIG. 7.

The electronic device 600 may include a microphone array 610, a movement detection circuit 620, and a processor 630. However, FIG. 8 only illustrates an exemplary configuration of the electronic device 600, and the electronic device 600 may further include other configurations not shown in FIG. 8. The microphone array 610 and the processor 630 may be configured and operated similarly to the microphone array 210 and the processor 230, respectively.

The microphone array 610 may include a plurality of microphones. By way of example, the microphone array 610 may include three microphones 611, 612, and 613, but the inventive concept is not limited thereto.

The microphone array 610 may receive a sound a2 through the microphones 611, 612, and 613. As described with reference to FIG. 2, the microphones 611, 612, and 613 may generate the signals k31, k32, and k33, respectively, based on the sound a2. The signals k31, k32, and k33 may include information on the sound a2 recognized by the microphones 611, 612, and 613. As the positions of the microphones 611, 612, and 613 are somewhat different, the signals k31, k32, and k33 may also be different.

When the electronic device 600 is moved from the position p1 to the position p2, the microphone array 610 may receive a sound a4 through the microphones 611, 612, and 613. The microphones 611, 612, and 613 may generate the signals k41, k42, and k43, respectively, based on the sound a4. The signals k41, k42, and k43 may include information on the sound a2 recognized by the moved microphones 611, 612, and 613, and may be different from each other.

When the electronic device 600 is moved from the position p1 to the position p2, the movement detection circuit 620 may generate movement data related to the position p1 and the position p2. The movement data may include various information related to the movement of the electronic device 600 (more particularly, the movement of the microphones 611, 612, and 613 of the electronic device 600). For this, the movement detection circuit 620 may include an accelerator sensor.

Referring to Equation 2, the movement detection circuit 620 may calculate the movement distance (xt, yt) and the movement angle θ of the electronic device 600 using the accelerator sensor. Here, the movement angle θ may be related to the movement direction of the electronic device 600.

xₜ=∫∫a_{z}dt yₜ=∫∫a_{y}dtθ=∫∫αdt[Equation 2]

xt is a movement distance to the x axis, yt is a movement distance to the y axis, and θ is a movement angle. ax is an acceleration in the x-axis direction, ay is an acceleration in the y-axis direction, and a is an angular acceleration. The acceleration in the x-axis direction, the acceleration in the y-axis direction, and the angular acceleration may be measured by the accelerator sensor. xt, yt, and θ may be calculated by integrating ax, ay, and a twice over time.

Referring to Equation 3, the movement detection circuit 620 may obtain a new coordinate axis 540 using the movement distance (xt, yt) and the movement angle θ.

$$( \begin{matrix}{x}_{2} \\ {y}_{2} \\ 1\end{matrix} ) = ( \begin{matrix}cos θ & - sin θ & {x}_{t} \\ sin θ & cos θ & {y}_{t} \\ 0 & 0 & 1\end{matrix} ) ( \begin{matrix}{x}_{1} \\ {y}_{1} \\ 1\end{matrix} ) \qquad [ Equation 3 ]$$

(x1, y1) may represent the coordinate axis 520 before being changed. (x2, y2) may represent a newly changed coordinate axis 540. Referring to Equations 2 and 3, the coordinate axis 540 may be expressed based on the movement distance (xt, yt), the movement angle θ, and the coordinate axis 520.

The movement detection circuit 620 may generate information of the position p2 using the information of the position p1 and the information measured by the acceleration sensor. The information of the position p2 may be obtained based on the information of the position p1 and the movement data generated from the movement detection circuit 620.

The processor 630 may generate a result related to the position of the sound source 100. The results generated by the processor 630 may be a base for estimating the position of the sound source 100. By way of example, the results generated by the processor 630 may generate results that relate to the direction from the position p2 to the sound source 100 and the distance from the position p2 to the sound source 100.

The processor 630 may receive signals k31, k32, and k33 from the microphone array 610. As described with reference to FIG. 2, the processor 630 may generate a first result related to the position of the sound source 100 from the position p1 based on the signals k31, k32, and k33. The first result may include information on the direction from the position p1 to the sound source 100.

When the electronic device 600 is moved from the position p1 to the position p2, the processor 630 may generate information on the position p1 based on the information on the position p1 and the movement data.

The processor 630 may receive signals k31, k32, k33, k41, k42, and k43 from the microphone array 610. Similar to the case where the second result in FIG. 2 is generated, the processor 630 may generate a second result related to the position of the sound source 100 from the position p2, based on the information on the position p2 and the signals k31, k32, k33, k41, k42, and k43. The second result may include information on the direction from the position p2 to the sound source 100.

The processor 630 may generate a third result based on the first result, the second result, and the information on the position p2. The processor 330 may calculate a target position that corresponds to one of the positions on the path along the direction from the position p2 to the sound source 100 among the positions on the path along the direction from the position p1 to the sound source 100. The processor 630 may generate a third result based on the distance between the position p2 and the target position. The third result may include information on the distance from the position p2 to the sound source 100.

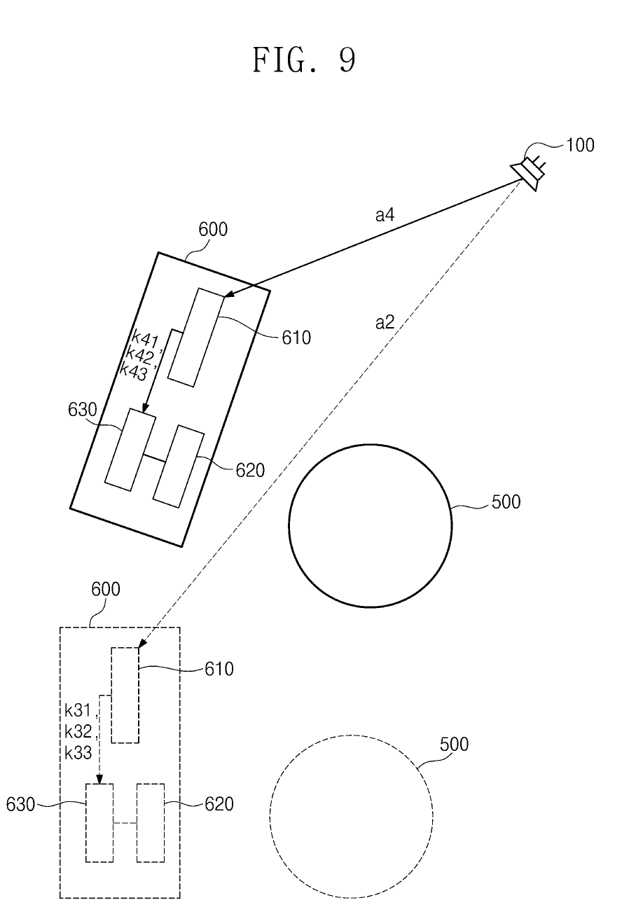

FIG. 9 is a conceptual diagram for explaining an exemplary method of measuring the position of a sound source using the electronic device of FIG. 8 when the electronic device is moved. In order to help understanding of the inventive concept, FIGS. 7 and 8 are referenced together.

The microphone array 610 may receive a sound a2 through the microphones 611, 612, and 613. The microphones 611, 612, and 613 may generate the signals k31, k32, and k33, respectively, based on the sound a2.

The processor 630 may generate a first result related to the position of the sound source 100 estimated from the position p1 based on the signals k31, k32, and k33. The first result may include information on the direction from the position p1 to the sound source 100.

When the electronic device 600 is moved from the position p1 to the position p2, the movement detection circuit 620 may generate movement data related to the position p1 and the position p2. The movement data may be generated based on the information of the position p1 and the information measured in the movement detection circuit 620 (e.g., an acceleration sensor).

When the electronic device 600 is moved from the position p1 to the position p2, the microphone array 610 may receive a sound a4 through the microphones 611, 612, and 613. The microphones 611, 612, and 613 may generate the signals k41, k42, and k43, respectively, based on the sound a4.

As described with reference to FIG. 8, the Processor 630 generates a second result related to the position of the sound source 100 estimated from the position p2 based on the signals k31, k32, k33, k41, k42, and k43 and the movement data. The second result may include information on the direction from the position p2 to the sound source 100.

As described with reference to FIG. 8, the processor 630 may generate a third result based on the first result, the second result, and the movement data. The third result may include information on the direction from the position p2 to the sound source 100 and information on the distance from the position p2 to the sound source 100. The position of the sound source 100 may be measured from the third result.

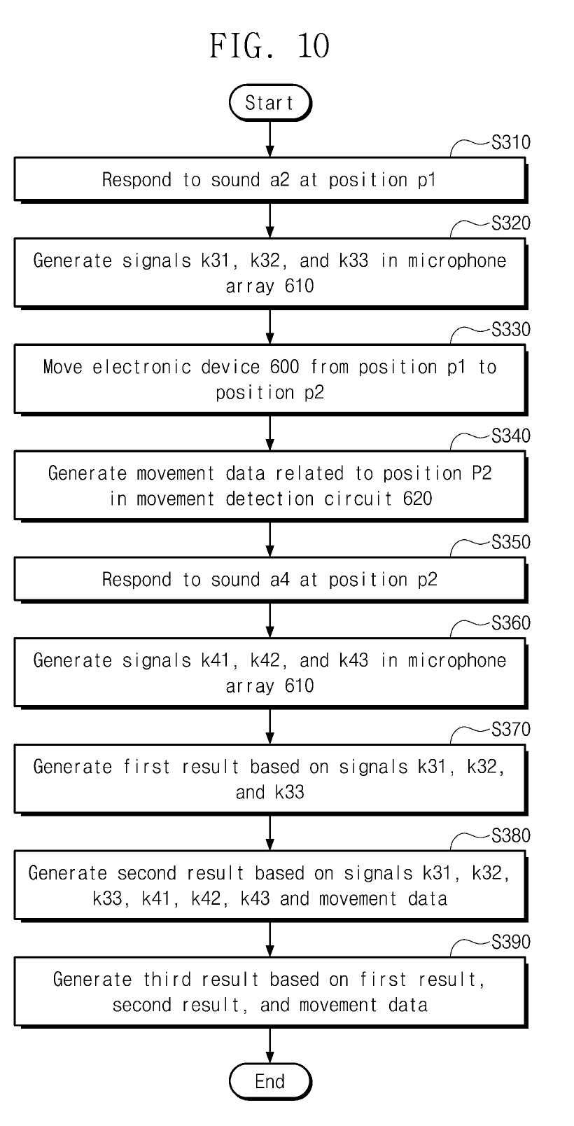

FIG. 10 is a flowchart for explaining an exemplary method of measuring the position of a sound source using the electronic device of FIG. 8. In order to help understanding of the inventive concept, FIGS. 7 and 8 are referenced together.

In operation S310, the microphone array 610 may receive a sound a2 from the position p1. In operation S320, the microphone array 610 may generate signals k31, k32, and k33 based on the sound a2.

In operation S330, the electronic device 600 may be moved from the position p1 to the position p2. In operation S340, the movement detection circuit 620 may generate movement data related to the position p1 and the position p2.

In operation S350, the microphone array 610 may receive a sound a4 from the position p2. In operation S360, the microphone array 610 may generate signals k41, k42, and k43 based on the sound a4.

In operation S370, the processor 630 may generate a first result based on the signals k31, k32, and k33. The first result may include information on the direction from the position p1 to the sound source 100.

In operation S380, the processor 630 may generate a second result based on the signals k31, k32, k33, k41, k42, and k43 and the movement data. The second result may include information on the direction from the position p2 to the sound source 100.

In operation S390, the processor 630 may generate a third result based on the first result, the second result, and the movement data. The third result may include information on the direction from the position p2 to the sound source 100 and information on the distance from the position p2 to the sound source 100.

However, the inventive concept is not limited to the embodiment described with reference to FIG. 10. For example, in operation S370, the processor 630 may generate a first result based on the signals k41, k42, and k43. The first result may include information on the direction from the position p2 to the sound source 100. As another example, although the embodiment of FIG. 10 illustrates estimating or measuring the position of the sound source 100 with respect to two positions p1 and p2, embodiments to estimate or measure the position of the sound source 100 with respect to three or more positions may be implemented.

For an operation of FIG. 10, the electronic device 600 may move over time. In one embodiment of the inventive concept, the electronic device 600 may collect information indicating the direction of the sound source 100 in relation to the plurality of positions, and may estimate or measure the position of the sound source 100 based on the collected information. That is, according to an embodiment of the inventive concept, instead of estimating the position of the sound source 100 at a single time, a temporally extended microphone array may be implemented as the electronic device 600 moves. The directions to the sound source 100 estimated at each position of the electronic device 600 may be used complementarily and the position of the sound source 100 may be accurately estimated or measured.

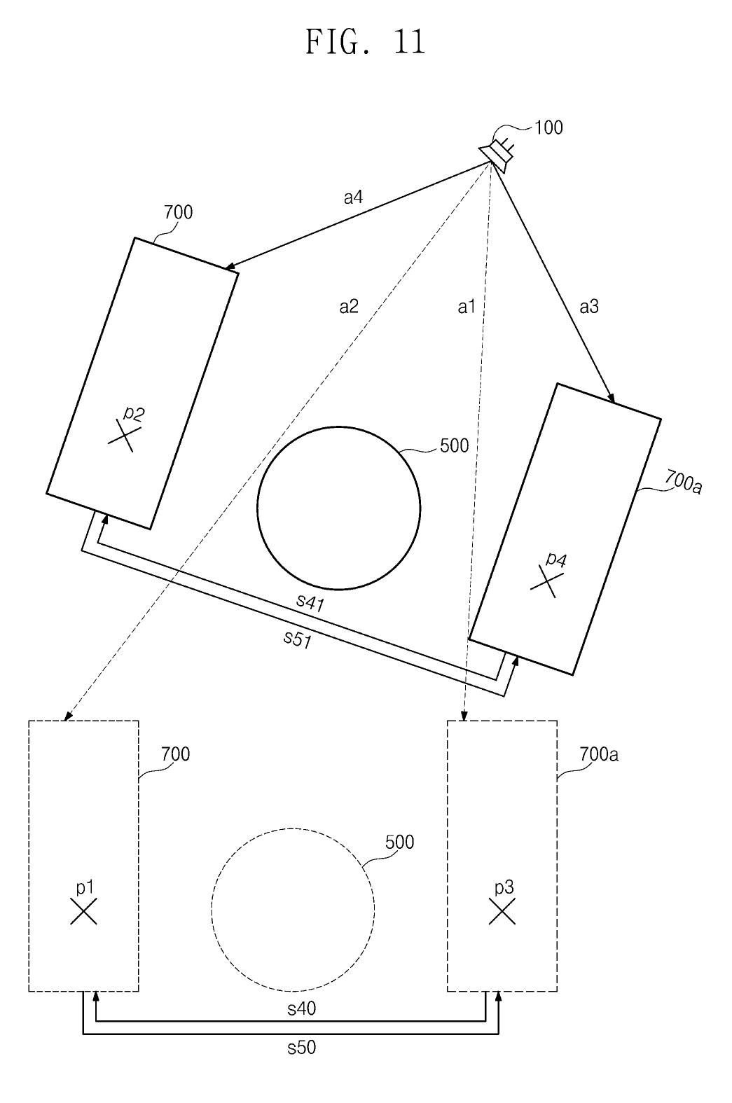

FIG. 11 is a block diagram illustrating a configuration for estimating the position of a sound source using a plurality of electronic devices when the electronic device is moved.

As time passes, the electronic device 700 may be moved from the position p1 to the position p2. As the electronic device 700 is moved from the position p1 to the position p2, the electronic device 700a may be moved from the position p3 to the position p4.

Before the electronic device 700 and the electronic device 700a are moved, the positions p1 and p3 may be the reference positions of the electronic devices 700 and 700a, respectively. After the electronic device 700 and the electronic device 700a are moved, the positions p2 and p4 may be the reference positions of the electronic devices 700 and 700a, respectively.

Before the electronic device 700 and the electronic device 700a are moved, the electronic device 700 may measure the position of the sound source 100 from the position p1 using the electronic device 700a. In this case, the electronic device 700 and the electronic device 700a may operate identical or similar to the electronic device 300 of FIG. 4 and the electronic device 200 of FIG. 3, respectively. Similarly, before the electronic device 700 and the electronic device 700a are moved, the electronic device 700a may measure the position of the sound source 100 from the position p3 using the electronic device 700.

Before the electronic device 700 and the electronic device 700a are moved, the electronic devices 700 and 700a may receive the sounds a2 and a1, respectively. The electronic device 700 may receive from the electronic device 700a a signal s40 that is generated based on the sound a1 in the electronic device 700a. The electronic device 700 may estimate the direction from the position p1 to the sound source 100 based on the sound a2 and the signal s40.

The electronic device 700a may receive from the electronic device 700 a signal s50 that is generated based on the sound a2 in the electronic device 700. The electronic device 700a may estimate the direction from the position p3 to the sound source 100 based on the sound a1 and the signal s50.

By way of example, the electronic device 700 and the electronic device 700a share information on the direction from the position p1 to the sound source 100 and information on the direction from the position p3 to the sound source 100. The electronic device 700 and the electronic device 700a may precisely measure the position of the sound source 100 based on the shared information.

After the electronic device 700 and the electronic device 700a are moved, the electronic device 700 may measure the position of the sound source 100 from the position p2 using the electronic device 700a. In this case, the electronic device 700 and the electronic device 700a may operate identical or similar to the electronic device 300 of FIG. 4 and the electronic device 200 of FIG. 3, respectively. Similarly, after the electronic device 700 and the electronic device 700a are moved, the electronic device 700a may measure the position of the sound source 100 from the position p4 using the electronic device 700.

After the electronic device 700 and the electronic device 700a are moved, the electronic devices 700 and 700a may receive the sounds a4 and a3, respectively. The electronic device 700 may receive from the electronic device 700a a signal s41 that is generated based on the sound a3 in the electronic device 700a. The electronic device 700 may estimate the direction from the position p2 to the sound source 100 based on the sound a4 and the signal s41.

The electronic device 700a may receive from the electronic device 700 a signal s51 that is generated based on the sound a4 in the electronic device 700. The electronic device 700a may estimate the direction from the position p4 to the sound source 100 based on the sound a3 and the signal s51.

By way of example, the electronic device 700 and the electronic device 700a share information on the direction from the position p3 to the sound source 100 and information on the direction from the position p4 to the sound source 100. The electronic device 700 and the electronic device 700a may precisely measure the position of the sound source 100 based on the shared information.

As another example, after the electronic device 700 and the electronic device 700a are moved, based on the position of the sound source 100 measured from the position p1 and the position of the sound source 100 measured from the position p1, the electronic device 700 may generate a result related to the position of the sound source 100. Based on the position of the sound source 100 measured from the position p3 and the position of the sound source 100 measured from the position p4, the electronic device 700a may generate a result related to the position of the sound source 100. In this case, each of the electronic device 700 and the electronic device 700a may operate identical or similar to the electronic device 600 of FIG. 8.

As another example, the electronic device 700 may precisely measure the position of the sound source 100 based on the direction from the position p1 to the sound source 100, the direction from position p3 to the sound source 100, the direction from the position p2 to the sound source 100, and the direction from the position p4 to the sound source 100. That is, the electronic device 700 may measure the position of the sound source 100 based on the directions to the sound source 100 that are estimated in relation to the plurality of positions.

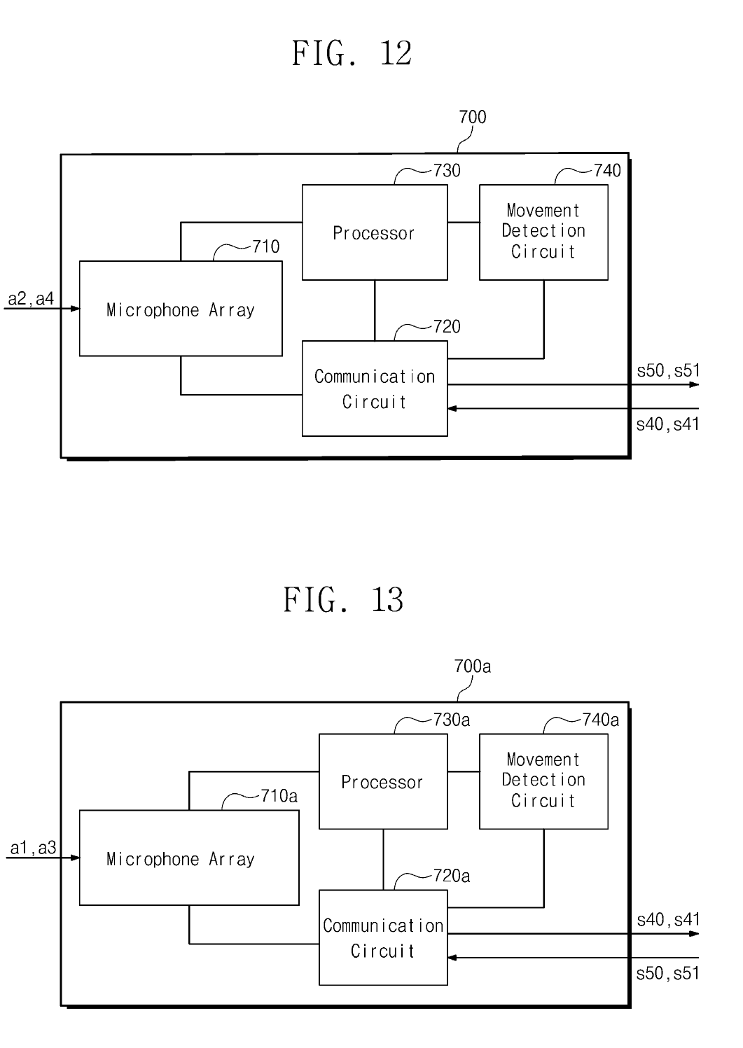

In one embodiment, the plurality of positions may be determined from the positions of the plurality of microphone array sets, and the communication circuit of the electronic device may be employed to share information of the direction to the sound source 100, which is estimated in relation to each position, with other devices. In another embodiment, the plurality of positions may be determined according to the movement of the microphone array set, and the movement detection circuit of the electronic device may be employed to obtain movement data. In the embodiment of FIG. 11, the communication circuit and the movement detection circuit may be employed together, and this configuration will be described further with reference to FIGS. 12 and 13.

FIG. 12 is a block diagram illustrating an exemplary configuration of the electronic device of FIG. 11.

The electronic device 700 may include a microphone array 710, a communication circuit 720, a processor 730, and a movement detection circuit 740. However, FIG. 11 only illustrates an exemplary configuration of the electronic device 700, and the electronic device 700 may further include other configurations not shown in FIG. 11.

The microphone array 710, the communication circuit 720, the processor 730, and the movement detection circuit 740 may operate identical or similar to the microphone array 310, the communication circuit 320, the processor 330, and the movement detection circuit 620.

Like the case where the signals k21, k22, and k23 are generated based on the sound a2 in FIG. 4, the microphone array 710 may generate the first signals based on the sound a2 from the sound source 100. Like the case where the signal s10 is generated in the electronic device 300 of FIG. 4, the communication circuit 720 may generate a signal s50 based on the first signals. The communication circuit 720 may transmit the signal s50 to the communication circuit 720a. The communication circuit 720 may receive the signal s40.

Like the case where a third result or a fourth result is generated in the electronic device 300 of FIG. 4, the processor 730 may generate a first result related to the direction from the position p1 to the sound source 100 based on the first signals and the signal s40.

When the electronic device 700 is moved from the position p1 to the position p2, like the case where the movement data is generated in the movement detection circuit 620 of FIG. 8, the movement detection circuit 740 may generate movement data related to the position p1 and the position p2. The processor 730 may obtain the information of the position p2 based on the information of the position p1 and the movement data.

When the electronic device 700 is moved from the position p1 to the position p2, like the case where the signals k21, k22, and k23 are generated based on the sound a2 in FIG. 4, the microphone array 710 may generate the second signals based on the sound a4 from the sound source 100. The communication circuit 720 may generate the signal s51 and may transmit the signal s51 to the communication circuit 720a. The communication circuit 720 may receive the signal s41.

Like the case where a third result or a fourth result is generated in the electronic device 300 of FIG. 4, the processor 730 may generate a second result related to the position of the sound source 100 from the position p2 based on the information of the position p2, the second signals, and the signal s41. The processor 730 may obtain the information of the position p2 based on the information of the position p1 and the movement data. The second result may include information on the direction from the position p2 to the sound source 100 and information on the distance from the position p2 to the sound source 100.

Like the case where a third result is generated in the electronic device 600 of FIG. 8, the processor 730 may generate a third result related to the position of the sound source 100 from the position p2 based on the information of the position p2, the first result, and the second result. The processor 330 may calculate a target position that corresponds to one of the positions on the path along the direction from the position p2 to the sound source 100 among the positions on the path along the direction from the position p1 to the sound source 100. The processor 730 may generate a third result based on the distance between the position p2 and the target position. The third result may include information on the distance from the position p2 to the sound source 100.

In some embodiments, the third result may be generated using the electronic device 700 positioned at the positions p1 and p2 and the electronic device 700a positioned at the positions p3 and p4. In this case, the position of the sound source 100 indicated by the third result may show high accuracy.

FIG. 13 is a block diagram illustrating an exemplary configuration of the electronic device of FIG. 11.

The electronic device 700a may include a microphone array 710a, a communication circuit 720a, a processor 730a, and a movement detection circuit 740a. However, FIG. 13 only illustrates an exemplary configuration of the electronic device 700a, and the electronic device 700a may further include other configurations not shown in FIG. 13.

The electronic device 700a may be configured to be identical or similar to the electronic device 700. As an example, the microphone array 710a, the communication circuit 720a, the processor 730a, and the movement detection circuit 740a may respectively provide configurations and operations corresponding to the microphone array 710, the communication circuit 720, the processor 730, and the movement detection circuit 740. Therefore, redundant description will be omitted below.

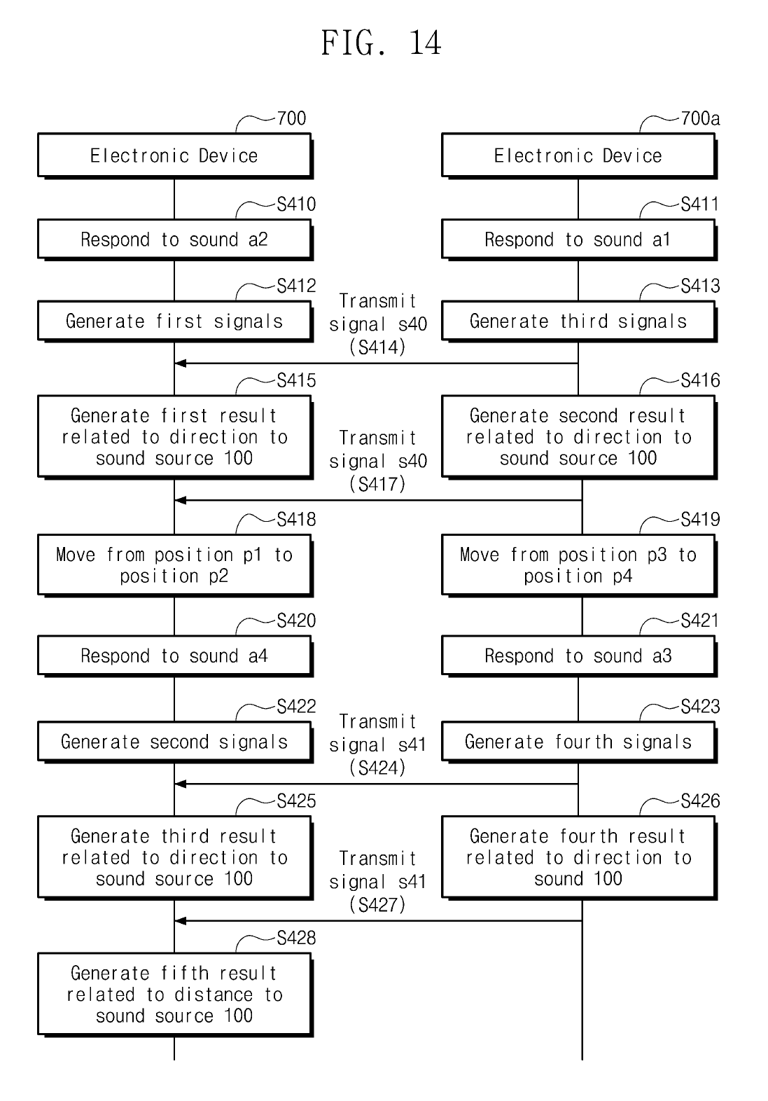

FIG. 14 is a flowchart illustrating one embodiment of communication between the electronic devices of FIG. 11.

In operation S410, the electronic device 700 may receive a sound a2. In operation S412, the electronic device 700 may generate the first signals based on the sound a2.

In operation S411, the electronic device 700a may receive a sound a1. In operation S413, the electronic device 700a may generate the third signals based on the sound a1.

In operation S414, the electronic device 700a may transmit the signal s40. The signal s40 may be generated based on the third signals. The signal s40 may include information on the sound a1 recognized by the electronic device 700a. The electronic device 700 may receive the signal s40.

In operation S415, the electronic device 700 may generate a first result based on the first signals and the signals s40. The first result may include information on the direction from the position p1 to the sound source 100.

In operation S416, the electronic device 700a may generate a second result based on the third signals. The second result may include information on the direction from the position p3 to the sound source 100.

In operation S417, the electronic device 700a may transmit the signal s40 based on the second result to the electronic device 700.

In operation S418, the electronic device 700 may be moved from the position p1 to the position p2. When the electronic device 700 is moved from the position p1 to the position p2, the electronic device 700 may generate movement data related to the position p1 and the position p2. As the electronic device 700 is moved from the position p1 to the position p2, the electronic device 700a may be moved from the position p3 to the position p4 in operation S419. The electronic device 700a may generate movement data related to the position p3 and the position p4.

In operation S430, the electronic device 700 may receive a sound a4. In operation S422, the electronic device 700 may generate the second signals based on the sound a4.

In operation S421, the electronic device 700a may receive a sound a3. In operation S423, the electronic device 700a may generate the fourth signals based on the sound a3.

In operation S424, the electronic device 700a may transmit the signal s41. The signal s41 may be generated based on the fourth signals. The signal s41 may include information on the sound a3 recognized by the electronic device 700a. The electronic device 700 may receive the signal s41.

In operation S425, the electronic device 700 may generate a third result based on the information of the position p2, the second signals and the signals s41. The third result may include information on the direction from the position p2 to the sound source 100.

In operation S426, the electronic device 700a may generate the fourth result based on the information of the position p4 and the fourth signals. The fourth result may include information on the direction from the position p4 to the sound source 100.

In operation S427, the electronic device 700a may transmit the signal s41 based on the fourth result to the electronic device 700.

In operation S428, the electronic device 700 may generate a fifth result based on the third result and the signals s41. The fifth result may include information on the distance from the position p2 to the sound source 100.

Although not shown in FIG. 14, the electronic device 700a may also generate results regarding the direction and distance from the position p4 to the sound source 100 based on the signals (e.g., signal s50 and/or signal s51) from the electronic device 700. In such a way, the electronic device 700 and the electronic device 700a may share direction information obtained in relation to a plurality of positions, and obtain accurate distance information based on shared direction information. Thus, the position of the sound source 100 may be accurately estimated or measured.

The components of each electronic device described above may be implemented with various hardware circuits (e.g., analog circuit, logic circuit, etc.) to perform the operations described above. Additionally or alternatively, each electronic device described above may include a processor device (e.g., a Central Processing Unit (CPU), an Application Processor (AP), etc.) that includes one or more processor cores. In this case, the components of each electronic device may be implemented as program code configured to perform the operations described above, and the processor device may execute a set of instructions of the program code. Additionally or alternatively, the components of each electronic device described above may be implemented as dedicated circuits (e.g., Field Programmable Gate Array (FPGA), Application Specific Integrated Circuit (ASIC), etc.) configured to perform the operations described above.

Configuration shown in each conceptual diagram should be understood only from the conceptual point of view. To help understanding the inventive concept, the form, structure, and size of each component in a conceptual diagram are exaggerated or reduced for expression. The actually implemented configuration may have a physical form different from that shown in each conceptual diagram. Each conceptual diagram does not limit the physical form of a component.

A device configuration shown in each block diagram is to help understanding the inventive concept. Each block may be formed of blocks of a smaller unit according to a function. Alternatively, a plurality of blocks may form a block of a larger unit according to a function. That is, the technical idea of the inventive concept is not limited by a configuration shown in a block diagram.

In some embodiments, an electronic device may estimate the position of the sound source more precisely by using the geometrically extended microphone array set than when estimating the position of the sound source by using the single microphone array. According to another embodiment, an electronic device may estimate the position of the sound source more precisely by using the time-extended microphone array set than when estimating the position of the sound source by using the single time.

Although the exemplary embodiments of the inventive concept have been described, it is understood that the inventive concept should not be limited to these exemplary embodiments but various changes and modifications may be made by one ordinary skilled in the art within the spirit and scope of the inventive concept as hereinafter claimed.

What is claimed is:

1. An electronic device comprising:
a first microphone array including a plurality of microphones configured to generate first signals related to a first sound in response to the first sound from a sound source; and
a processor configured to generate a first result related to a first direction to the sound source from a first reference position among first positions at which the first sound is received by the plurality of microphones based on second signals corresponding to a second sound received from the sound source at second positions separated from the first positions and the first signals, and generate a second result related to a distance to the sound source based on information on a second direction from a second reference position among the second positions to the sound source and the first result.

2. The electronic device of claim 1, wherein the processor is further configured to calculate a difference between times at which the first sound is received at the first positions based on waveforms of the first signals to generate the first result.

3. The electronic device of claim 1, wherein the processor is further configured to calculate a target position that matches one of positions on a path along the second direction from the second reference position among positions on a path along the first direction from the first reference position to generate the second result based on a distance between the first reference position and the target position.

4. The electronic device of claim 1, further comprising a communication circuit configured to communicate with a set of external devices that are spatially separated from a set of the electronic devices,
wherein the second positions correspond to positions at which the second sound is received by microphones included in a second microphone array of the external device.

5. The electronic device of claim 4, wherein the communication circuit is further configured to receive the second signals and the information of the second direction from the external device for the processor.

6. The electronic device of claim 4, wherein the communication circuit is further configured to transmit the first signals and the first result to the external device and receive the information of the second direction from the external device based on the first signals and the second signals.

7. The electronic device of claim 1, when the plurality of microphones move from the first positions to the second positions over time, further comprising a movement detection circuit configured to generate movement data related to a movement of the plurality of microphones.

8. The electronic device of claim 7, wherein the movement detection circuit comprises an acceleration sensor,
wherein the acceleration sensor is configured to calculate a movement distance and a movement direction of the plurality of microphones between the first positions and the second positions over the time to generate the movement data.

9. The electronic device of claim 7, wherein the processor is further configured to obtain information of the second positions, based on the information of the first positions and the movement data.

10. The electronic device of claim 1, wherein the first result and the second result are referred to for measuring a position of the sound source.

11. The electronic device of claim 1, wherein a first error between a measurement position of the sound source measured based on the first result and the second result and an actual position of the sound source is smaller than a second error between an estimated position of the sound source estimated only based on the first signals and the actual position of the sound source.

12. An electronic device comprising:
a first microphone array including a first plurality of microphones configured to generate first signals related to a first sound in response to the first sound from a sound source;
a first communication circuit configured to receive second signals corresponding to a second sound received from the sound source at second positions spatially separated from first positions at which the first sound is received by the first plurality of microphones, and receive information on a first direction from the second positions to the sound source; and
a first processor configured to generate a first result related to a second direction from the first positions to the sound source based on the first signals and the second signals, and generate a second result related to a first distance to the sound source based on the first result and the information of the first direction,
wherein the first microphone array, the first communication circuit, and the first processor are included in a first device set.

13. The electronic device of claim 12, further comprising:
a second microphone array including a second plurality of microphones configured to generate the second signals in response to the second sound at the second positions;
a second communication circuit configured to transmit the generated second signals to the first communication circuit and receive the first signals generated by the first plurality of microphones from the first communication circuit; and
a second processor configured to generate a third result related to the first direction based on the generated second signals and the received first signals,
wherein the second microphone array, the second communication circuit, and the second processor are included in a second device set that is physically independent of the first device set.

14. The electronic device of claim 13, wherein the second communication circuit is further configured to transmit the third result as the information of the first direction to the first communication circuit and receive the first result from the first communication circuit,
wherein the second processor is further configured to generate a fourth result related to a second distance to the sound source based on the third result and the received first result.

15. The electronic device of claim 14, wherein the first result, the second result, the third result, and the fourth result are referred to for measuring a position of the sound source.

16. The electronic device of claim 14, when the first plurality of microphones move from the first positions to third positions over time, further comprising a movement detection circuit configured to generate movement data related to a movement of the first plurality of microphones.

17. The electronic device of claim 16, wherein the first plurality of microphones are further configured to generate third signals related to a third sound in response to the third sound from the sound source at the third positions,
wherein the first processor is further configured to generate a fifth result related to a third direction from the third positions to the sound source based on the third signals, and generate a sixth result related to a third distance to the sound source based on the fifth result and the second result.

18. The electronic device of claim 17, wherein the second positions correspond to positions at which the second sound is received by microphones included in a second device set that is physically independent of the first device set,
wherein as the first plurality of microphones move from the first positions to the third positions, the microphones of the second device set move from the second positions to the fourth positions.

19. The electronic device of claim 18, wherein the first communication circuit is further configured to receive fourth signals corresponding to a fourth sound received from the sound source at the fourth positions and receive information on a fourth direction from the fourth positions to the sound source,
wherein the first processor is further configured to generate the fifth result related to the third direction based on the third signals and the fourth signals, and generates the sixth result related to the third distance based on the fifth result, the information of the fourth direction, and the second result.
